(19) United States
(12) Patent Application Publication
(10) Pub. No.: US 2020/0047359 A1
(43) Pub. Date: Feb. 13, 2020

(54) STRAWBERRY KNIFE

(71) Applicant: William Alan Schenk, Hammonton, NJ (US)

(72) Inventor: William Alan Schenk, Hammonton, NJ (US)

(21) Appl. No.: 16/056,680

(22) Filed: Aug. 7, 2018

(51) Int. Cl. B26B 3/04; B26D 3/26

(52) U.S. Cl. CPC B26B 3/04; B26D 3/26

(57) ABSTRACT

A cutting device adapted to slice a strawberry in one swipe is provided. The cutting device is specifically dimensioned to operative engage and slice a single strawberry into a plurality of slices including slicing off the calyx with one cut. The cutting portion provides a cutting frame circumscribing a strawberry-shaped void. Traversing the void is spaced apart longitudinal cutting blades and one latitudinal cutting blade which does not bisect the space of the top portion of the strawberry-shaped void.

### BACKGROUND OF THE INVENTION

The present invention relates to food cutting devices and, more particularly, to a cutting device adapted to slice strawberries in one swipe.

Those interested in slicing strawberries would need to utilize a cutting implement, such as a knife, repeatedly for each strawberry. The first cut would most likely be to remove the top greenery, or calyx, but additional cuts would be required to slice the individual strawberry into a plurality of slices, which is the preferred way to slice them for either food preparation—e.g., as a topping for cereal or dessert—or for decoration—e.g., when garnishing a fruit platter. And that process would need to be repeated for each strawberry.

As can be seen, there is a need for a cutting device adapted to slice a strawberry in one swipe, wherein the cutting device is specifically dimensioned to operative engage and slice a single strawberry into a plurality of slices including slicing off the calyx with one cut, thereby making the process of slicing each strawberry a one-step process.

### SUMMARY OF THE INVENTION

In one aspect of the present invention, a device for cutting strawberries, includes a cutting head provides sidewalls defining a void having a general strawberry shape; and a plurality of spaced apart parallel longitudinal cutting blades traversing said void.

In another aspect of the present invention, the device for cutting strawberries, includes a cutting head provides sidewalls defining a void having a general strawberry shape; the cutting head includes a top portion extending between two opposing top ends; two side portions, each side portion extending from a respective top end so that the two side portions converge at a tip end generally midpoint between the two opposing top ends and spaced apart from the top portion; a plurality of spaced apart parallel longitudinal cutting blades traversing said void; a latitudinal cutting blade bisecting said plurality of longitudinal cutting blades; and a handle extending transversely from the top portion at approximately a forty-five-degree angle relative to the cutting head.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a left elevation view of an exemplary embodiment of the present invention;

FIG. 4 is a front elevation view of an exemplary embodiment of the present invention;

FIG. 5 is a perspective view of an exemplary embodiment of the present invention; and

FIG. 6 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a cutting device adapted to slice a strawberry in one swipe, wherein the cutting device is specifically dimensioned to operative engage and slice a single strawberry into a plurality of slices including slicing off the calyx with one cut. The cutting portion provides a cutting frame circumscribing a strawberry-shaped void. Traversing the void is spaced apart longitudinal cutting blades and one latitudinal cutting blade which does not bisect the space of the top portion of the strawberry-shaped void.

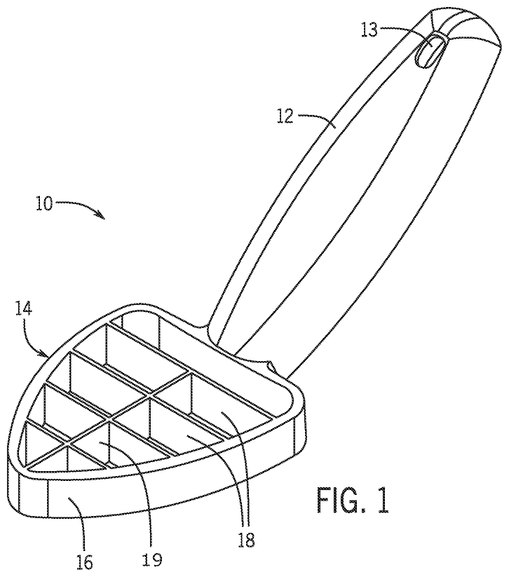

Referring to FIGS. 1 through 6, the present invention may include a cutting device 10 dimensioned and adapted for slicing a single strawberry into a plurality if slices with one stroke. The cutting device 10 provides a cutting head 14 having a handle 12 transversely extending therefrom. The cutting device 10 may be made by any sufficiently strong material adaptive to forming cutting blades, such as metallic materials, various plasticized materials, ceramic or the like.

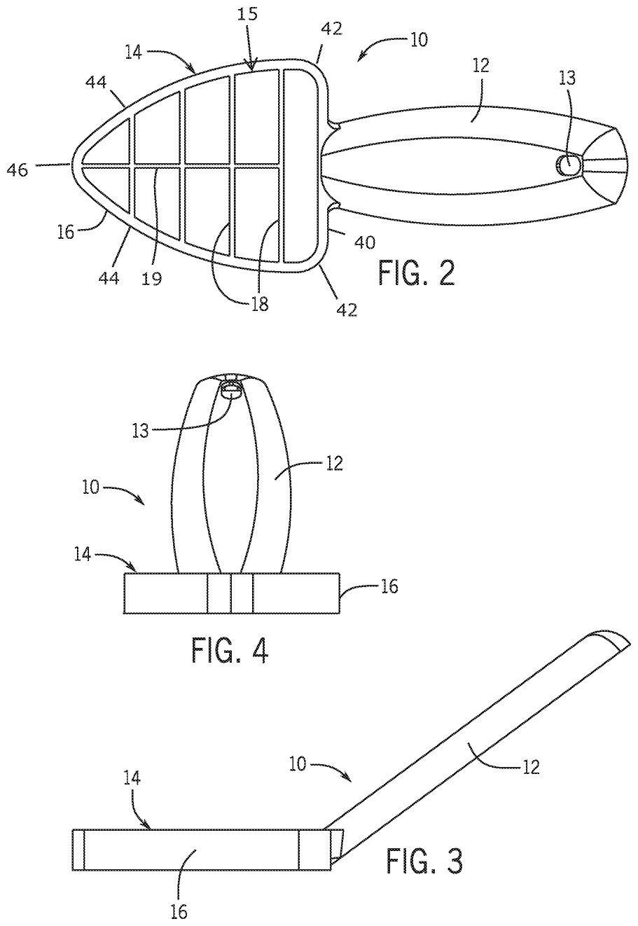

The cutting head 14 may be planar and provide a cutting frame 16 dimensioned and adapted to define a strawberry shape void 15, as illustrated in FIG. 2. The cutting frame 16 may be generally continuous sidewalls. Traversing the void 15 and extending between the cutting frame 16 may be a plurality of planar longitudinal blades 18 and a latitudinal blade 19.

The sidewalls of the cutting frame 16 may provide a generally linear top portion 40 extending between two opposing top ends 42 and two opposing side portions 44, each side portion 44 extending from opposing top ends 42 toward each other so as to taper to and converge at a tip end 46, generally halfway between the opposing top ends 42 but spaced apart from the top portion 40. A distance between opposing top ends 42 may be between two and three inches. A distance between the tip end 46 and the top portion 40 may be between two and four inches.

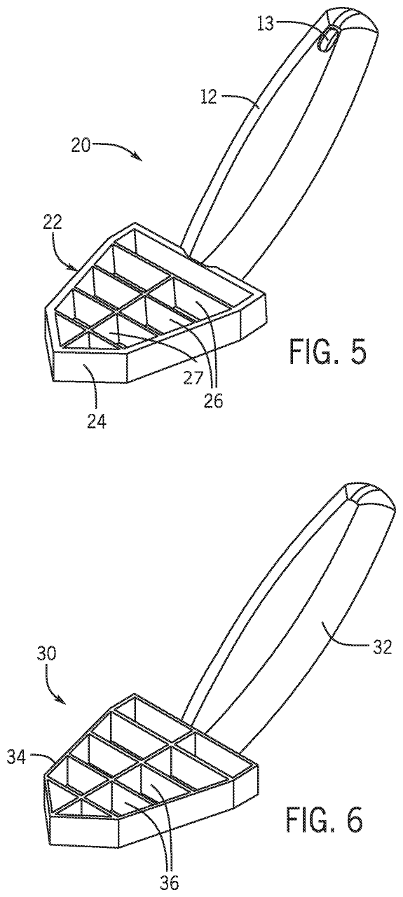

In certain embodiments each end 42 and 46 may be a rounded corner so as to suggest or mimic the natural curve of a traditional strawberry shape. In other embodiments 20 and 30, as illustrated in FIGS. 5 and 6, respectively, each end is not rounded but rather forms edged joints so that the cutting head 22, cutting blades 26 and 27 or 36, and cutting frame 24 or 34 have a different look, which may be easier to manufacture, though still provide a generally strawberry shape.

The longitudinal blades 18 may be longitudinal in that they extend between the opposing side portions 44, while the latitudinal blade 19 is generally orthogonal relative to the longitudinal blades 18. The plurality of longitudinal blades 18 may be spaced apart generally evenly between the top portion 40 and the tip end 46. The longitudinal blade 18 being closest to the top portion 40 being known as the top longitudinal blade 18. The latitudinal blade 19 may extend from the tip end 46 and terminate at the top longitudinal blade 18, bisecting the remaining longitudinal blades 18. The void between the top longitudinal blade 18 and the top portion 40 being dimensioned and adapted for severing the calyx from the flesh of the strawberry. In one embodiment, 30, the latitudinal blade bisects all of the longitudinal blades 36, as illustrated in FIG. 6.

The handle 12 extends transversely from the top portion 40. In certain embodiments at a forty-five-degree angle or ranging from a thirty to sixty-degrees angle. The handle 12 may extend between four and five inches or longer. Adjacent a distal end of the handle may be a hanging hole 13.

A method of using the present invention may be as follows. The cutting device 10 disclosed above may be provided. A user would press the cutting device 10 down on a strawberry on a cutting surface so that the top longitudinal blade 18 severs the calyx from an upper fleshy portion of said strawberry and so the cutting frame 14 generally circumscribes the periphery of said strawberry. The result being the blades 18 and 19 dissecting the flesh portion of the strawberry into a plurality of slices, most of which would be half the girth of said strawberry because of the latitudinal blade 19.

It should be understood, of course, that the foregoing relates to exemplary embodiments of the invention and that modifications may be made without departing from the spirit and scope of the invention as set forth in the following claims.

What is claimed is:

1. A device for cutting strawberries, comprising:
a cutting head provides sidewalls defining a void having a general strawberry shape; and
a plurality of spaced apart parallel longitudinal cutting blades traversing said void.

2. The device of claim 1, further comprising a latitudinal cutting blade bisecting said plurality of longitudinal cutting blades.

3. The device of claim 1, further comprising a handle extending transversely from a top portion of the cutting head.

4. The device of claim 1, wherein the handle extends at approximately a forty-five-degree angle relative to the cutting head.

5. The device of claim 4, further comprising a hanging hole provide near a distal end of the handle.

6. The device of claim 1, wherein the cutting head comprises:
a top portion extending between two opposing top ends;
two side portions, each side portion extending from a respective top end so that the two side portions converge at a tip end generally midpoint between the two opposing top ends and spaced apart from the top portion.

7. The device of claim 6, wherein the two top ends and the tip end are rounded.

8. The device of claim 2, wherein each longitudinal and latitudinal cutting blade is disposed completely within said void.

9. The device of claim 6, wherein a space between the top portion and an adjacent longitudinal blade is not bisected.

10. The device of claim 6, the top portion being between two and three inches in length.

11. A device for cutting strawberries, comprising:
a cutting head provides sidewalls defining a void having a general strawberry shape;
the cutting head comprises:
a top portion extending between two opposing top ends;
two side portions, each side portion extending from a respective top end so that the two side portions converge at a tip end generally midpoint between the two opposing top ends and spaced apart from the top portion;
a plurality of spaced apart parallel longitudinal cutting blades traversing said void;
a latitudinal cutting blade bisecting said plurality of longitudinal cutting blades; and
a handle extending transversely from the top portion at approximately a forty-five-degree angle relative to the cutting head.

12. The device of claim 11, the top portion being between two and three inches in length.

13. The device of claim 11, further comprising a hanging hole provide near a distal end of the handle.

14. The device of claim 11, wherein the two top ends and the tip end are rounded.

15. The device of claim 11, wherein each longitudinal and latitudinal cutting blade is disposed completely within said void.

16. The device of claim 11, wherein a space between the top portion and an adjacent longitudinal blade is not bisected.
